(19) United States
(12) Patent Application Publication
(10) Pub. No.: US 2025/0340314 A1
(43) Pub. Date: Nov. 6, 2025

(54) System and Method for Guiding Non-guided Ammunitions to Targets Using Drones with Smart Cable System

(71) Applicant: QUOC VIET LUONG, Castro Valley, CA (US)

(72) Inventor: QUOC VIET LUONG, Castro Valley, CA (US)

(21) Appl. No.: 19/177,490

(22) Filed: Apr. 11, 2025

Related U.S. Application Data
(60) Provisional application No. 63/632,895, filed on Apr. 11, 2024.

(51) Int. Cl. B64U 70/20; B64D 1/04; B64D 5/00; B64U 20/87; B64U 101/18

(52) U.S. Cl. CPC B64U 70/20; B64D 1/04; B64D 5/00; B64U 20/87; B64U 2101/18

(57) ABSTRACT

The present invention provides a system and method including a master drone equipped with a target guidance system (TGM), and slave drones releasably attached to the master drone by a smart cable system. The slave drone carries and delivers non-guided ammunition directly to targets. The TGM identifies the enemy targets, their coordinates, and releases at least one slave drones to destroy the enemy targets.

### PRIORITY CLAIMS

The present invention claims priority of a provisional patent application under 35 C.F.R. § 1.53 (b), entitled, “Apparatus and Method for Guiding a Non-guided Ammunitions” No. 63/632,895 filed on Apr. 11, 2024.

### FIELD OF THE INVENTION

The present invention relates generally to munitions. More particularly, the present invention relates munitions released from unmanned aerial vehicles (UAV) or drones.

### BACKGROUND ART

Traditional non-guided ammunition, such as artillery shells, mortars, and rockets, have been the backbone of military arsenals due to their simplicity, reliability, and low cost. However, their effectiveness is constrained by their lack of precision. These munitions are typically used in a “fire and forget” manner, where the projectile's trajectory cannot be altered once launched. This results in a probabilistic approach to target engagement, requiring large volumes of fire to achieve the desired effect, which can lead to collateral damage and resource wastage.

In contrast, guided munitions, equipped with navigation systems (such as GPS, heat seekers, or laser guidance), offer the ability to strike targets with high accuracy, reducing the quantity of ordnance required and minimizing collateral damage. Despite these advantages, guided weapons come with significant drawbacks such as high costs and vulnerability to electronic warfare including jamming.

The integration of advanced guidance systems, sensors, and electronics significantly increases the cost per unit compared to non-guided munitions. This high expense limits the number that can be deployed, especially in large-scale or prolonged conflicts.

Modern battlefields are saturated with electronic warfare capabilities, including jamming, spoofing, and cyberattacks, which can degrade or neutralize the effectiveness of guided munitions. The reliance on external signals (like GPS) makes these weapons susceptible to disruption, leading to mission failure or unintended consequences.

The sophisticated technology in guided munitions necessitates extensive maintenance, support, and training, further elevating operational costs and logistical demands. Current military operations heavily rely on precision strikes provided by guided weapons. However, these systems are expensive due to their reliance on advanced components like tactical-grade GPS, navigation sensors, and sophisticated on-board computers. Despite their precision and advanced technology, these systems remain susceptible to electronic warfare tactics, including jamming, intercepting, chaffing, and spoofing. Meanwhile, non-guided ammunitions, which are abundant and inexpensive, lack the capability to deliver precision strikes, leading to a gap in military capabilities where cost-effective precision is necessary.

Therefore, what are needed is a new method and weapon system that are insusceptible to electronic warfare and other surface to air (STA) anti-missiles.

What are needed is a method and weapon system that are precise and yet independent of sophisticated and expensive guidance systems.

That is, what is needed is a method and weapon system that can be launched from drones and UAVs using a target guidance module (TGM).

What are needed is a weather-proof method and weapon system that are inexpensive and yet precise.

What are needed are drones and UAVs system and method that can dynamically select different means of communication so that information is reliably transmitted to the base.

In addition, what are needed are drones and UAVs system and method that can autonomously fly to the destination without being GPS/GNSS spoofed.

This invention addresses these challenges by introducing a drone communication system that utilizes non-radio frequency signals-specifically, light, acoustic, and thermal signals—for robust and secure communication between the drone and the base station. Additionally, the system incorporates advanced artificial intelligence (AI) software to process these signals and extract critical navigational and operational data, enabling drones to autonomously determine their GPS coordinates even in the absence or compromise of GNSS signals. This approach significantly mitigates the vulnerabilities associated with traditional drone operation methods, providing a groundbreaking solution to the pressing challenges of drone navigation and communication in electronically contested environments.

### SUMMARY OF THE INVENTION

The present invention addresses the need to turn non-guided ammunitions into precision-guided munitions that are both cost-effective and resistant to electronic warfare. It proposes a novel system comprising a master drone and one or more slave drones. The master drone is equipped with a Target Guidance Module (TGM) comprising advanced sensing and computing capabilities to determine the optimal trajectory for one or more slave drone(s), which are essentially converted non-guided munitions. The slave drone executes navigation commands received from the master drone through a physical cable connection, enabling precise strikes without the need for onboard sophisticated navigation systems, thus reducing costs and electronic warfare (EW) vulnerabilities. The novelty of this invention is that the slave drone(s) possesses all the capabilities of the master drone without having the physical assets (hardware and software) of the master drone onboard, making it a cheap, disposable, yet very effective EW-immune guided weapon.

Another object of the present invention is to provide a wired communication in place of an ubiquitous and commonplace wireless communication for preventing interference between two devices is known in the art, such wired implementation in a drone system (i.e, a master drone and a slave drone) faces several drawbacks such as possibility of tangling of cables to the drone copters, as well as damaging to cable end connections due to tension forces caused by different speeds between these two devices.

Another object of the present invention is to provide slave drones using only disposable camera(s), or none at all, while the master drone utilizing Target Guidance Module(s) (TGM). For clarification purpose, a TGM is a devise that comprises RGB cameras with super zoom and low light capability, thermal sensors, a gimbal for mechanical stabilization, a laser rangefinder, a built-in computer loaded with an AI software for electronic stabilization, object detection, object tracking, target positioning, trajectory calculation and other tasks. Therefore, in a conventional wireless system, a wireless slave drone would normally require an on-board TGM to process signals from the cameras, perform an identification and trajectory calculation process to determine the target location and to navigate the slave drone to the target location. In contrast, a novelty feature of the invention is the removal of advanced cameras and hardware from the slave drone to the master drone which performs all of the above mentioned processes to navigate the slave drone to the target location, thereby result in a slave drone that does not carry any advanced and costly camera hardware, wireless data link, GPS (Global Positioning System) module, or any on-board computer, for cost saving on a dispensable slave drone.

By utilizing a cable communication system, several embodiments are made possible. In the first embodiment, the slave drone comprises only a glider which consists of aerodynamic wings and control surfaces (ailerons, elevators, and rudder) for flight control, all mechanically linked to servos that respond to the master drone's commands. In the second embodiment, the slave drone comprises only a powered flying kit which flies towards the target, adjusting its flight path based on real-time commands from the master drone through the connecting cable. In the third embodiment, the slave drone comprises a powered flying kit and sensor modules, for navigating to the target under the master drone's guidance while feeding imagery raw data from these sensors to the master drone. Alternately, any combination of the glider, the powered flying kit and the sensor module would be within the scope of this invention.

Further, the invention is not limited to a unmanned aerial vehicles (UAVs), other modifications to a non-UAV or different types of flying objects or aircrafts are within the scope of the present invention. For example, the master drone can be modified to be a Manned Aerial Vehicle. Accordingly, any modification may be within the scope of the invention.

### BRIEF DESCRIPTION OF THE DRAWINGS

The accompanying drawings, which are incorporated in and form a part of this specification, illustrate embodiments of the invention and, together with the description, explain the principles of the invention.

FIG. 1 is a diagram illustrating an operation principle in accordance with an exemplary embodiment of the present invention.

FIG. 2 is diagram illustrating a structure of a master drone in accordance with an exemplary embodiment of the present invention.

FIG. 3 is a schematic diagram of a target guidance module in accordance with an exemplary embodiment of the present invention.

FIG. 4A-FIG. 4C are a schematic diagram of slave drones in accordance with an exemplary embodiment of the present invention.

FIG. 5 is a perspective diagram showing components of gliding kit in accordance with an exemplary embodiment of the present invention.

FIG. 6A-FIG. 6B are a perspective diagrams of a powered flying kit in accordance with another embodiment of the present invention.

FIG. 7 is a diagram of an autonomous cable retriever (reeler) in accordance with an aspect of the present invention.

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Within the scope of the present description, the reference to “an embodiment” or “the embodiment” or “some embodiments” means that a particular feature, structure, or element described with reference to an embodiment is comprised in at least one embodiment of the described object. The sentences “in an embodiment” or “in the embodiment” or “in some embodiments” in the description do not therefore necessarily refer to the same embodiment or embodiments. The feature, structures or elements can be furthermore combined in any adequate way in one or more embodiments.

Within the scope of the present description, the word “drones” include different forms of unmanned flying targets including unmanned aerial vehicles, drones, multi-copters with propellers affixed at different locations on the drones.

Within the scope of the present description, the words “coupling”, “connecting”, “coupled”, “coupling”, “connections”, “coupler”, “bolted”, “laid”, “connected” “positioned”, “attached”, “attaching”, “affixed”, “affixing” are used to mean attaching between two described members using hardware such as screws, nails, tongs, prongs, clips, spikes, staples, pins, male and female nuts, buttons, sleeves, lugs, pivots, cams, handles, bars, fasteners, connectors, ball-bearing latches, 3D gimbals, or the likes that meet the MIL-STD commercial off the shelf (COTS).

Within the scope of the present description, the word “remote control”, “remote controlling” is used to mean wired and/or wireless controlling. Wired connections include electrically conducting wires, cables, lines, coaxial cables, strips, or the likes that meet the MIL-STD. Conducting wires are made of conductors such as coppers, aluminum, gold, or the likes that meet the MIL-STD. Wireless connections include electromagnetic waves and long-range wireless communication channels include UHF/VHF radio frequencies 900 MHz and 2.4 Ghz.

Within the scope of the present description, the word “rotation”, “rotating”, “rotate” includes clockwise and/or counterclockwise direction.

Within the scope of the present description, the limitation “rigid” used in the present invention includes non-inflatable materials such as light steel, carbon composite, polymer, epoxy based resins, etc.

Within the scope of the present invention, the Cartesian XYZ coordinate (x, y, z) also includes equivalent spherical coordinate (r, ⊖, ϕ), and/or cylindrical coordinate (r, ⊖, z) that can determine the directions of movements or coordinates of the enemy's targets including GPS coordinates.

Within the scope of the present description, the word motors refer to the rotors that drive the propellers, tilt rotors, electric rotors, hybrid rotors, AC brushless motors (BLAC), DC brushless motors (BLDC), also known as permanent magnet synchronous motors (PMSM).

Within the scope of the present description, the word targets refer to the enemy's tanks, armored vehicles, military transportation means, trucks, ships, troops, bunkers, buildings, tents, airports, and aircrafts on the ground, the enemy's ground missile launchers, or the likes.

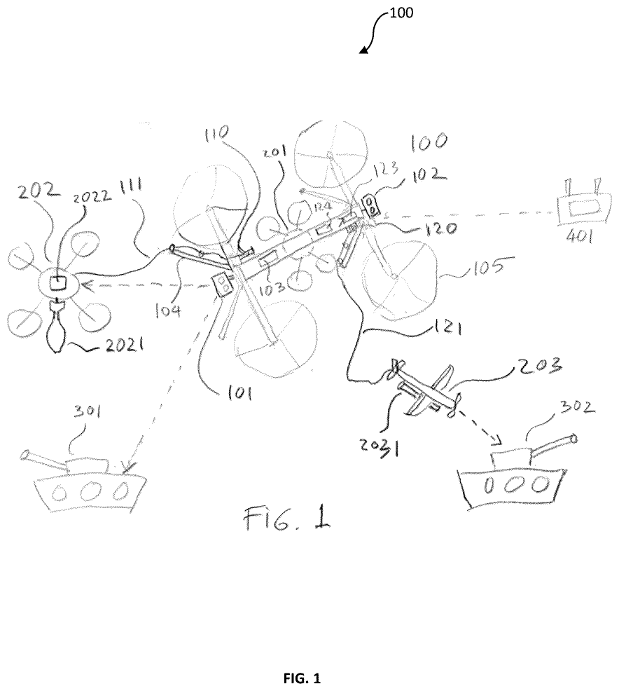

Referring now to the drawings and specifically to FIG. 1, a diagram 100 illustrating a general operation principle in accordance with various aspects of the present invention. The system operates as follows:

A master drone 101 flies to the vicinity of the target area and releases the slave drones 201-202. Master drone 101 and the slave drones 201-202 are connected by a cable 111, which can be a fiber optic or a similar material that allows the transmission of data between them. Master drone 101 uses its Target Guidance Module (TGM) to detect and identify targets 301-302 and wirelessly streams the video feed to human operators. The human operators can decide to launch the slave drones 201-202 to hit either targets 301-302 and use the TGM on the master drone 101 and in certain embodiments the camera sensors on the slave drones to navigate the slave drones to the target using the cable communication. The slave drones then explode on impact with the target, while the master drone returns to the base.

A system 100 comprises two primary components: a master drone 101 and a slave drones 201-202, connected by a durable, lightweight cable 111. Master drone 101 is a sophisticated unmanned aerial vehicle (UAV) equipped with radar, wind sensors, on-board computers, and a TGM comprising electro-optical and infrared (EO-IR) cameras, laser rangefinder, GNSS module, IMU and compass, an integrated computer system, and an AI-driven software. The slave drone 201-202 is a simpler UAV, designed to carry and deliver non-guided ammunition to a specified targets 301-302 based on the navigation commands received from master drone via a physical cable system. front Target Guidance Module 101, rear Target Guidance Module 102, INS (Inertial Navigation System) 103, landing gear 104, propeller guard 105, cable reeler 110, cable reeler 120, communication cable 111, Communication cable 121, digital data link unit 123, battery 124, ground control station 401, slave drone mounted on the master drone 201, second slave drone flying to a target 202, INS on slave drone 2022, non-guided ammunition 2021, another powered slave drone flying to a target 203, non-guided ammunition 2031, enemy tank 301, second enemy tank 302.

Central to system 100 is the integration of a sophisticated master drone, equipped with a TGM comprising advanced EO-IR cameras, laser rangefinder, sensors and computing capabilities, which are responsible for the high-level analysis, trajectory computation, and strategic planning necessary for mission success. The master drone employs state-of-the-art electro-optical and infrared (EO-IR) cameras, laser rangefinder, radar technology, and wind sensors, all managed by an on-board computer running advanced AI algorithms. These elements collectively facilitate the autonomous navigation of the drone, the identification and verification of targets, the calculation of optimal trajectories, and the execution of complex command and control tasks.

In concert with the master drone, the system employs a slave drone, which is designed to carry and deliver the non-guided ammunition directly to the target. The slave drone is engineered in three distinct configurations to suit various mission requirements: a glider kit for short-range engagements, a powered flying kit for extended reach, and an enhanced powered version equipped with disposable sensors and cameras for real-time data acquisition and transmission.

The operational synergy between the master and slave drones is maintained via a robust and lightweight connecting cable, ensuring a secure and uninterrupted flow of power and data. This cable facilitates the precise execution of navigation commands and the relay of sensory data, essential for adapting to dynamic combat environments and executing precise strikes.

The dual-drone system offers a cost-effective and highly adaptable solution to the limitations of traditional munitions, providing enhanced precision and reduced collateral damage in strike operations. Moreover, the unique configuration and communication link between the master and slave drones significantly diminish the system's susceptibility to electronic warfare, thereby increasing the likelihood of mission success in contested environments. Through this innovative approach, the invention allows the slave drone(s) to have all the capabilities of the master drone without having the physical assets (hardware and software) of the master drone onboard, making it a cheap, disposable, yet effective EW-immune guided weapon.

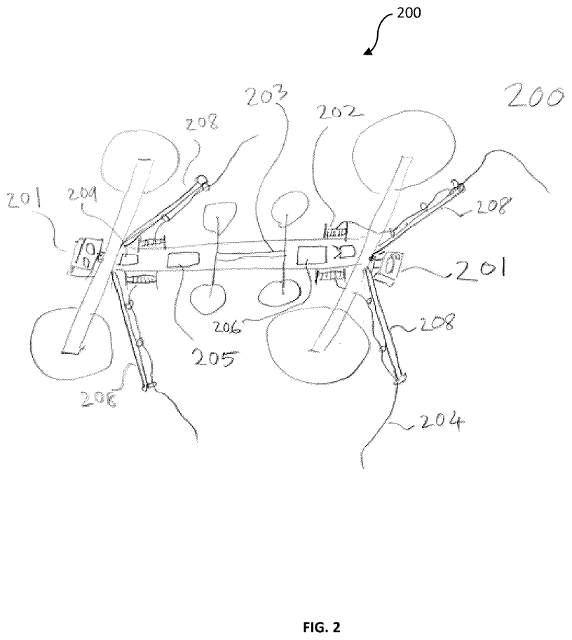

Referring now to the drawings and specifically to FIG. 2, a diagram 200 illustrating a scenario where a drone uses an anti-jamming technique of the present invention to prevent jamming and GPS spoofing from the enemy in an area where communication transmission path 298 is blocked by physical structure such as a forest 203 and mountain ranges 204. cable reeler 202, a slave drone 203, communication cable 204, battery 205, Inertial Navigation System (INS) 206, Landing gears 208, a radar unit 209, a digital data link unit 210.

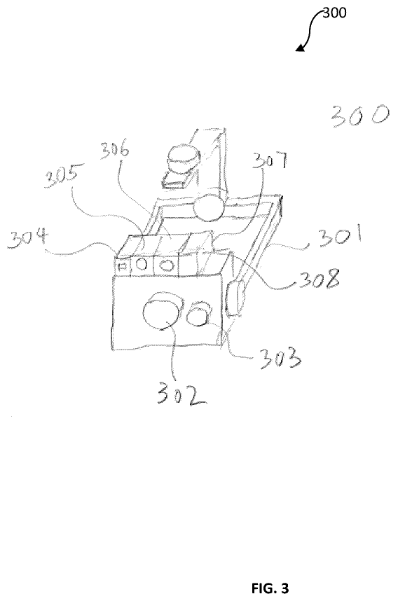

Next referring to FIG. 3, various exemplary embodiments of a target guidance module (TGM) 300. gimbal 301, a RGB super zoom camera 302, a thermal camera 303, IMU and compass 304, a global national satellite system (GNSS) module 305, a laser rangefinder 306, an embedded computer 307, a target Guidance AI module 308.

### Calculating GNSS Locations

a. GNSS Location of the Target:

Detection: The TGM uses its AI software to autonomously detect targets (e.g., tanks, ships, weaponry, soldiers) through inputs from its RGB super zoom camera, thermal camera, and possibly other sensors. This step involves image and pattern recognition algorithms that can identify specific target characteristics even in challenging conditions.

Distance Measurement: Once a target is identified, the TGM employs its laser rangefinder to accurately measure the distance to the target. This is crucial for calculating the GNSS location of the target relative to the master drone.

Altitude and Attitude Adjustment: Using the IMU (Inertial Measurement Unit) and compass, the TGM determines the master drone's altitude and attitude (orientation). This information adjusts the distance measurement for any angular discrepancies due to the master drone's pitch, roll, or yaw.

GNSS Location Calculation: With the known GNSS location of the master drone (from its GNSS module), the computed distance to the target, and the altitude and attitude adjustments, the TGM calculates the GNSS location of the target. This involves converting relative distance and directional information into absolute GNSS coordinates.

b. GNSS Location of the Slave Drone:

Distance Measurement to Slave Drone: The TGM measures the distance to the slave drone, similar to how it measures the distance to the target. If applicable, camera signals from the slave drone (via a physical cable) could aid in determining its precise location relative to the master drone.

GNSS Location Calculation for Slave Drone: Using the master drone's GNSS location, the distance to the slave drone, and adjustments for the master drone's altitude and attitude, the GNSS location of the slave drone is calculated. This step transforms the relative positioning into absolute GNSS coordinates.

### Computing the Trajectory

a. Trajectory Calculation:

Data Integration: The TGM integrates the GNSS locations of both the target and the slave drone. It also considers current environmental conditions (like wind speed and direction) if such data is available, which can affect the trajectory.

Optimal Path Determination: Utilizing algorithms that account for factors such as distance, speed, altitude differences, and potential obstacles, the TGM calculates the optimal trajectory for the slave drone to hit the target. This calculation ensures the most efficient and effective path, minimizing exposure to threats and energy consumption.

Navigation Command Generation: Based on the calculated trajectory, the TGM generates navigation commands for the slave drone. These commands are tailored to guide the slave drone precisely along the computed path.

b. Navigation Command Execution:

Transmission via Physical Cable: The navigation commands are transmitted to the slave drone through a physical cable connection. This ensures immunity to electronic warfare tactics that could disrupt wireless communication.

Execution by Slave Drone: The slave drone, following the received navigation commands, adjusts its flight path accordingly to hit the target. Despite lacking advanced hardware, the precise guidance from the master drone enables effective target engagement.

This process combines advanced sensing, computing, and communication technologies, allowing for precise target engagement with minimal hardware on the slave drone, optimizing cost-effectiveness and reducing vulnerability to electronic warfare.

Radar System: For mapping and environmental assessment, the master drone incorporates a sophisticated radar system. This radar is capable of penetrating adverse weather conditions, providing topographical data, and detecting targets and obstacles, which is crucial for navigating through complex environments and planning the flight path of the slave drone.

Wind Sensors: Wind sensors on the master drone measure wind speed and direction at different altitudes, aiding in flight stabilization and trajectory prediction. This data is essential for calculating the optimal launch moment and flight path for the slave drone, especially when dealing with unpowered variants like the glider.

On-board Computer with AI (or AI-based) programs: An advanced on-board computer system, loaded with preprogrammed AI algorithms, controls the master drone. These AI programs are designed for autonomous navigation, target location identification, trajectory calculation, and dynamic command transmission to the slave drone. The AI's decision-making capabilities enable real-time adjustments to the mission plan based on live data and changing conditions.

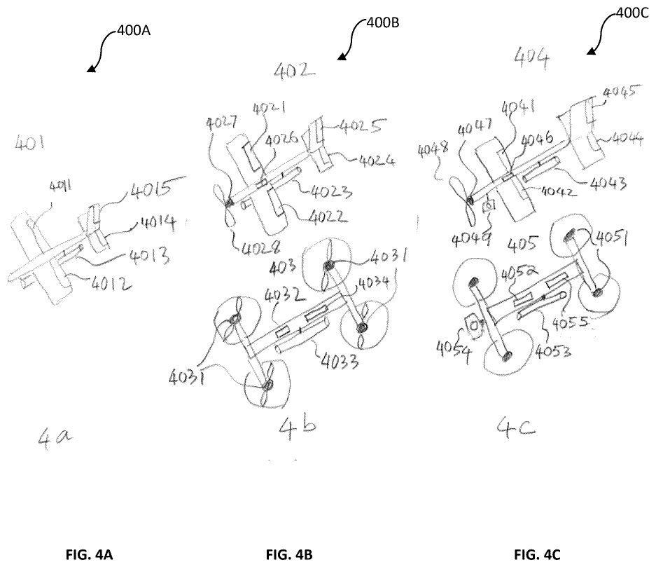

Now referring to FIG. 4, various components of a glider kit are illustrated.

### Slave Drone

### Approach 1: Glider Kit (First Embodiment)

glider kit 400A, whole glider kit 401, right aileron 4011, left aileron 401, non-guided ammunition 4013, elevator 4014, udder 4015.

Design: The glider kit is a minimalist design, prioritizing low cost and reduced electronic footprint. It consists of aerodynamic wings and control surfaces (ailerons, elevators, and rudder) for flight control, all mechanically linked to servos that respond to the master drone's commands.

Operation: This variant depends entirely on the master drone for navigation guidance. After being released, it glides towards the target, adjusting its flight path based on real-time commands from the master drone through the connecting cable.

### Approach 2: Powered Flying Kit (Second Embodiment)

powered Flying Kit 400B, whole Powered fixed wing flying kit 402, right aileron 4021, left aileron 4022, non-guided ammunition 4023, elevator 4024, rudder 4025, INS 4026, motor 4027, propeller 4028, powered Multirotor Flying Kit 403, motors 4031, INS 4032, a Non-guided ammunition 4033.

Design: This version includes a propulsion system and an INS, which can be either a fixed-wing or multi-copter setup, providing the slave drone with independent flight capability over longer distances.

Operation: After being released, it flies towards the target, adjusting its flight path based on real-time commands from the master drone through the connecting cable.

Powered Flying Kit with cameras 400C, powered fixed wing flying kit with camera 404, right aileron 4041, left aileron 4042, non-guided ammunition 4043, elevator 4044, rudder 4045, INS 4046, motor 4047, propeller 4048, camera 4049, a powered Multirotor Flying Kit with camera 405, motors 4051, INS 4052, non-guided ammunition 4053, disposable camera 4054, battery 4055

One important feature should be noted for the above first and second embodiments is that the slave drone does not include any camera or camera sensor, any imagery data link or GPS signal link, and any on-board computer, thereby provide a very low cost kamikaze drone, which is a novelty feature of the invention, for cost saving on kamikaze drones.

### Approach 3: Enhanced Powered Flying Kit with Camera and/or Sensors (Third Embodiment)

Design: Building on Approach 2, this slave drone variant includes disposable cameras and/or sensors, adding reconnaissance capabilities. The slave drone passes through imagery data from these sensors to the master drone.

Operation: This approach allows the slave drone to not only navigate to the target under the master drone's guidance but also to gather and relay environmental and target-specific data to the master drone allowing the master drone to enhance mission accuracy and effectiveness.

Table 1 below lists components and features of a master drone and slave drones as described in the above first, second and third embodiments.

| | | | | Powered | | |
|---|---|---|---|---|---|---|
| | | | Powered | flying kit | | |
| | | Glider | flying kit | with | | |
| | | Flying kit | (fixed wing | camera | | |
| | | (navigation | or | and/or | Master | |
| | Components | surfaces) | multicopter) | sensors | drone | References |
| 1 | Airframe | yes | | yes | yes | yes |
| 2 | Battery | yes | | Yes | Yes | Yes |
| 3 | Wire | | | | | |
| | communication | | | | | |
| | with Mother-drone | | | | | |
| 3.1 | Imagery/Sensor | no | | no | yes | yes |
| | data | | | | | |
| 3.2 | Command and | yes | | yes | yes | yes |
| | guidance data | | | | | |
| 4 | Motors | No | | Yes | Yes | Yes |
| 5 | INS including IMU | no | | Yes | Yes | Yes |
| 6 | EO-IR Camera | | | | | |
| | Sensors | | | | | |
| 6.1 | EO, No zoom | no | | no | Yes | Yes |
| 6.2 | EO, Super zoom | no | | no | no | Yes |
| | Capability | | | | | |
| 6.3 | Thermal IR | no | | no | no | Yes |
| | camera sensor | | | | | |
| 7 | Laser rangefinder | No | | No | No | Yes |
| 8 | GNSS module | No | | No | No | Yes |
| 9 | Wireless data link | no | | no | no | Yes |
| 10 | Radar | no | | no | no | Yes |
| 11 | Lidar | no | | no | no | Yes |
| 12 | Onboard | no | no | no | Yes | |
| | computer | | | | | |
| | AI navigation | | | | | |
| 13 | programs (third | no | no | no | Yes | |
| | person view) | | | | | |
| | Capabilities | precision- | precision- | precision- | | |
| | | guided in | guided in | guided in | | |
| | | short | medium | medium | | |
| | | distance | distance | distance | | |
| | | (within | (within a few | (within a | | |
| | | 100 m | km radius | few km | | |
| | | radius | depending on | radius | | |
| | | depending | battery size of | dependin | | |
| | | on altitude | the slave | g on | | |
| | | of master | drone)- | battery | | |
| | | drone) | 100% use of | size of the | | |
| | | | third person | slave | | |
| | | | view for | drone) | | |
| | | | precision strike | FPV | | |
| | | | | Fusion of third | | |
| | | | | person | | |
| | | | | view and | | |
| | | | | for | | |
| | | | | precision | | |
| | | | | strike-00% | | |
| | | | | third | | |
| | | | | person | | |
| | | | | view for | | |
| | | | | thermal | | |
| | | | | navigation | | |

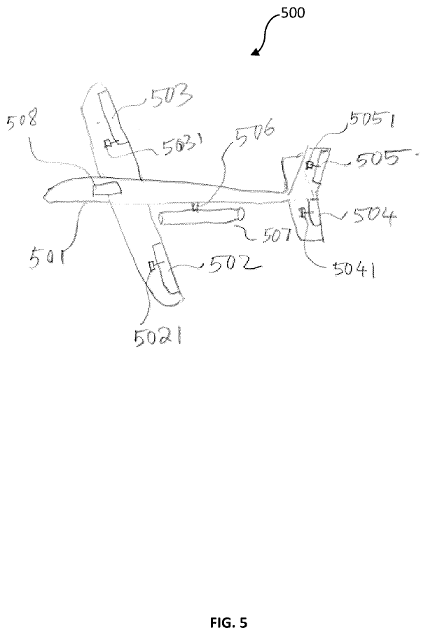

Referring to FIG. 5, various components of a powered flying kit 500 are illustrated. Powered flying kit 500 includes a fuselage 501, a left aileron 502, a servo to control left aileron 5021, a right aileron 503, a servo to control right aileron 5031, an elevator 504, a servo to control elevator 5041, a rudder 505, a servo to control rudder 5051, an ammunition mount 506, a non-guided ammunition 507, and a battery 508.

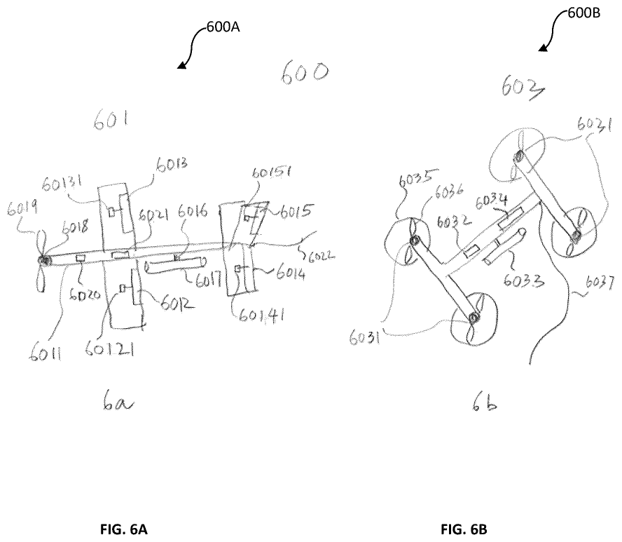

Next referring to FIG. 6A-FIG. 6B, diagrams 600A-600B illustrate two different types of slave drones respectively. Fxed wing powered flying kit 600A includes fixed wing powered flying kit 601, a fuselage 6011, a left aileron 6012, a servo to control left aileron 60121, a right aileron 6013, a servo to control right aileron 60131, an elevator 6014, a servo to control elevator 6041, a rudder 6015, a servo to control rudder 60151, an ammunition mount 6016, a non-guided ammunition 6017, a motor 6018, a propeller 6019, an INS 6020, a battery 6021, and a communication cable 6022.

Multirotor powered flying kit 600B includes a whole multirotor powered flying kit 603, motors 6031, INS 6032, a non-guided ammunition 6033, a battery 6034, propeller guards 6035, propellers 6036, a communication cable 6037

The difference between First Person View (FPV) and Third Person View in drone navigation is primarily the perspective from which the pilot controls and experiences the flight:

First Person View (FPV): In FPV, the pilot controls the drone while experiencing the flight through the drone's camera, as if they were on board the drone itself. This is typically achieved using a live video feed transmitted from the drone's camera to a display device, such as goggles or a screen, giving the pilot a real-time view from the drone's perspective12. FPV is popular for immersive flying experiences and is often used in drone racing and freestyle flying.

Third Person View (TPV): TPV involves controlling the drone while viewing it from a separate external camera or line of sight, providing a broader perspective of the drone's surroundings.

TPV offers better situational awareness since pilots have a wider field of view, allowing them to see obstacles, other aircraft, or potential hazards that may not be visible in FPV.

TPV can enable pilots to fly the drone at greater distances or heights with more confidence, as they have a better view of the drone's position relative to its surroundings.

### Autonomous Cable Reeler System

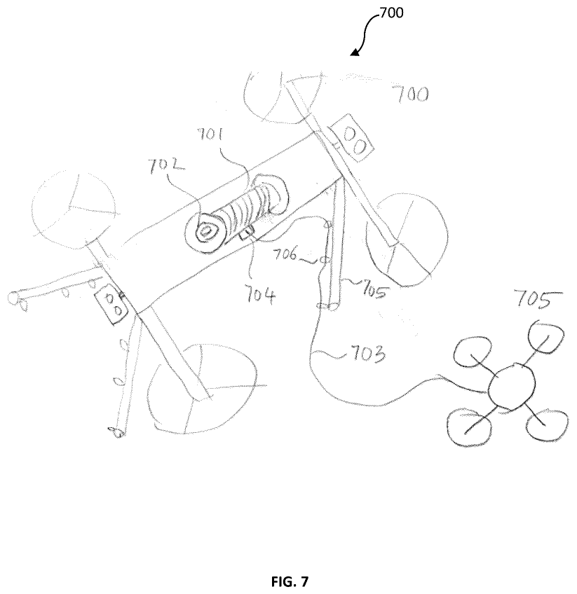

Now referring to FIG. 7, a smart cable system 700 for providing a physical connection between a master drone and a slave drone is illustrated. Smart cable system 700 includes a reeler 701, a reeler motor controlled by AI program 702, a communication cable 703, a cable tensioner and arranger 704, landing gears 705, and landing gear rings 706.

### Connecting Cable

Design and Functionality: The connecting cable is engineered to be robust yet lightweight, capable of withstanding the rigors of operational deployment while minimizing drag and weight. It serves as the lifeline between the master and slave drones, facilitating a secure and continuous transmission of power and data signals.

Operational Role: The autonomous cable reeler system ensures that the slave drone remains under the master drone's control throughout the mission, providing a real-time, jam-resistant communication link. This connection is crucial for the precise execution of navigation commands and the relay of sensory data (in the case of Approach 3), thereby significantly reducing the risk of electronic warfare interference. The autonomous cable reeler system comprises: a communication module that enables the cable communication system between a master drone and multiple slave drones. a cable reeler attached to the master drone, which comprises: a plurality of drums that holds the cable for connecting the master drone and the slave drones. The drums can vary in size and capacity depending on the length and thickness of the cable and the number and type of slave drones.
a plurality of powered winders that can wind and unwind the cable on the drums according to the movement and distance of the slave drones. The winders are driven by an corresponding electric motor and is controlled by an AI program module that optimizes the cable management.
a plurality of first cable end connectors for connecting cables to the master drone, each connector is movably or fixedly positioned at different locations and angles.
a plurality of tension sensors that measures the tension of the cable and sends the data to the AI program module. The tension sensors ensures that each cable is neither too loose nor too tight, as both can cause damage to the cables, cable end connectors or the slave drones. The tension sensor can also detect any obstacles or faults in the cables and alert the AI program module and/or the remote human operator. The tension sensors can be located either at the master drone or at the slave drone, or both.
a plurality of second cable end connectors, each for connecting a cable to a slave drone and is movably or fixedly positioned at a location and angle that would minimize the tangle of the cable to the copters of the slave drone.

### System Operation

The operational mechanism of the proposed invention, which turns non-guided ammunition into guided weapons using a master and slave drone system, can be elaborated as follows:

### System Setup and Preparation

### Integration of Components:

The master drone is equipped with a TGM comprising advanced sensors such as EO-IR cameras, GNSS module, IMU, compass, laser range finder and an integrated computer system loaded with AI software for navigation, target identification, and trajectory calculation.

The slave drone is configured based on the mission requirements: it can be a simple glider with control surfaces for short-range missions or a powered drone with or without disposable sensors for longer-range missions.

A robust cable connects the master and slave drones, providing a secure communication link for navigation commands and power transfer (if needed).

### Pre-Mission Planning and Loading:

Non-guided ammunition, such as mortars, is securely attached to the slave drone.

Mission parameters are set, including target coordinates, rules of engagement, and fallback protocols in case of mission abort or failure.

### Deployment and Ingress

### Launch and Transit to Operational Area:

The master drone, carrying the slave drone, takes off and heads towards the target area. The master drone flies at an altitude and speed optimized for mission requirements and threat avoidance.

During transit, the master drone continually assesses environmental conditions (wind speed, obstacles) and adjusts its flight path accordingly.

### Approaching the Target:

As the master drone nears the target area, it reduces altitude and speed to minimize detection by enemy sensors.

The master drone uses its sensors and AI program to perform a detailed reconnaissance of the target area, identifying potential threats, confirming target location, and assessing environmental conditions for optimal approach (i.e, stay off the target at a predetermined distance) and attack. (support for claim 18)

### Attack and Execution

### Target Acquisition and Final Approach:

The master drone relays real-time imagery and data back to the command center, where operators validate the target and give final clearance for the attack.

Once cleared, the master drone calculates the optimal trajectory for the slave drone to ensure a precise strike on the target.

### Launch of the Slave Drone:

The slave drone is released, and it descends or propels towards the target, depending on its configuration (glider or powered).

The master drone continuously transmits navigation commands through the cable, adjusting the slave drone's path in response to real-time feedback from its own sensors and, if available, from sensors on the slave drone. Note here that the master drone can release slave drones either each one at a time or all simultaneously, and capable of controlling multiple slave drones simultaneously.

### Impact and Assessment

### Strike and Impact:

The slave drone follows the precise trajectory calculated by the master drone, adjusting for last-minute changes in target position or environmental factors.

Upon reaching the target, the non-guided ammunition is detonated, achieving the intended strike with precision.

### Post-Strike Assessment and RTB (Return to Base):

After the detonation of the ammunition, the master drone collects post-strike imagery and data for damage assessment and confirmation of target neutralization.

The master drone then retracts the cable and returns to base, following a safe route to avoid enemy detection and engagement.

### Electronic Warfare and Countermeasures

### Electronic Warfare Resistance:

The master drone uses its sensors onboard to continuously monitor the electronic signature and susceptibility to jamming, interception, or spoofing and makes decision to stay outside of the interception sphere (created by the enemy).

Encrypted communication between the master drone and command center.

The master drone uses the physical cable to communicate with the slave drone.

### Adaptive Tactics:

The AI software onboard the master drone continuously analyzes the threat environment for electronic warfare threats and adapts its tactics accordingly, using evasion maneuvers, electronic countermeasures, or mission abort decisions to preserve the integrity of the operation.

The above operational mechanism outlines a comprehensive and detailed approach for converting non-guided ammunition into precision-guided munitions using a master and slave drone system, with built-in flexibility and robustness against electronic warfare threats.

This invention presents a novel system and method designed to enhance the accuracy and efficacy of conventional non-guided ammunitions, transforming them into precision-guided munitions through the innovative use of a dual-drone configuration. The dual-drone system offers a cost-effective and highly adaptable solution to the limitations of traditional munitions, providing enhanced precision and reduced collateral damage in strike operations. Moreover, the unique configuration and communication link between the master and slave drones significantly diminish the system's susceptibility to electronic warfare, thereby increasing the likelihood of mission success in contested environments. Through this innovative approach, the invention allows the slave drone(s) to have all the capabilities of the master drone without having the physical assets (hardware and software) of the master drone onboard, making it a cheap, disposable, yet effective EW-immune guided weapon.

While the arrangement of different embodiments has been described as set forth above, it is to be understood that the invention is not limited to the above descriptions. As an example, a wire communication can be made between the remote human operator and the master drone utilizing the cable system as described above, or the master drone can be a Manned Aerial Vehicle.

It should be noted that the AI program as described above can be implemented in hardware, in software, or in both hardware and software. In certain implementations, the AI program may be described in the general context of computer-executable instructions, such as program modules, being executed by a computer. The computer typically includes a variety of computer-readable media. Computer-readable media can be any available media that can be accessed by the computer and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other non-transitory medium which can be used to store the desired information and which can be accessed by the computer.

In summary, the invention describes an UAV system for guiding a non-guided ammunition carried in a low cost kamikaze drone. The invention further provides advantages of a physical cable communication system which is resistant to electronic warfare. Since one skilled in the art would recognize that there are many obvious variations that can be made to the above described embodiments, it is to be understood that the invention is not limited to the described embodiments except as defined in the following claims.

The foregoing description details certain embodiments of the invention. It will be appreciated, however, that no matter how detailed the foregoing appears in text, the invention can be practiced in many ways. As is also stated above, it should be noted that the use of terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

After the foregoing description of the novel features and the details of certain embodiments of the invention above, it will be appreciated that the mechanical parts, the propeller driving motors, and electrical parts, sensors, controller boards, radars, transceivers, and the process to assemble them together to build multicopter drones 400, 600, and 700, a person of ordinary skills in the related arts can build the multicopter drones of the present invention without undue experiment. Therefore, they need not to be described in detail herein.

After the foregoing description details certain embodiments of the invention above, it will be appreciated that remote controlling and the operations of multicopter drones 400, and 700, a person of ordinary skills in the related arts and trained how to operate multicopter drones or the likes would know how to fly the multicopter drones of the present invention. Therefore, the controls and operations of the multicopter drones of the present invention need not to be described in detail herein.

This invention introduces a drone communication system that employs non-radio frequency signals-light, acoustic, and thermal signals-enhanced by advanced artificial intelligence (AI) for robust, secure communications and autonomous navigation.

Comprising an Air Communication Module (ACM) and a Ground Communication Module (GCM), this system utilizes a wide array of sensors and devices to transmit encoded information through alternative signal mediums, circumventing conventional electronic warfare methods. The AI software's role is pivotal, extracting and encoding critical data from drone-captured imagery and sensor data into these non-traditional signals for secure transmission. Furthermore, this system empowers drones with the capability to calculate their GPS location autonomously, leveraging information from the base station and onboard sensors, thus ensuring reliability even when conventional signals are compromised.

The bi-directional communication facilitated by this invention, encompassing the downlink and uplink processes, ensures secure data exchange and supports essential navigational commands and real-time location updates. This is indispensable for maintaining operational effectiveness in environments where electronic warfare tactics or GNSS signal denial is prevalent.

By offering a solution that is resilient against electronic warfare attacks and GNSS signal disruption, this invention substantially enhances the security, reliability, and operational capabilities of drones across military, surveillance, and civilian applications. This groundbreaking approach not only mitigates vulnerabilities associated with traditional drone operation methods but also opens new possibilities for drone utilization in electronically contested or GNSS-denied environments, marking a significant advancement in unmanned aerial systems technology.

Within the scope of the present description, the reference to “an embodiment” or “the embodiment” or “some embodiments” means that a particular feature, structure or element described with reference to an embodiment is comprised in at least one embodiment of the described object. The sentences “in an embodiment” or “in the embodiment” or “in some embodiments” in the description do not therefore necessarily refer to the same embodiment or embodiments. The particular feature, structures or elements can be furthermore combined in any adequate way in one or more embodiments.

### REFERENCE NUMERALS

101 Front Target Guidance Module
102 Rear Target Guidance Module
103 INS (Inertial Navigation System)
104 Landing gear
105 Propeller guard
110 One cable reeler
120 One Cable reeler
111 Communication cable
121 Communication cable
123 Digital data link
124 battery
125 Ground control station
201 slave drone mounted on the master drone
202 slave drone flying to a target
2022 INS on slave drone
2021 Non-guided ammunition
203 another powered slave drone flying to a target
2031 Non-guided ammunition
301 enemy tank
302 second enemy tank
200 master drone system
201 Target Guidance Module
202 Cable reeler
203 a slave drone
204 communication cable
205 battery
206 Inertial Navigation System (INS)
208 Landing gears
209 radar
210 Digital data link
300 Target Guidance Module (TGM)
301 gimbal
302 RGB super zoom camera
303 thermal camera
304 IMU and compass
305 global national satellite system (GNSS) module
306 laser rangefinder
307 embedded computer
308 target Guidance AI program
4a glider kit
401 whole glider kit
4011 right aileron
4012 left aileron
4013 Non-guided ammunition
4014 Elevator
4015 Rudder
4b Powered Flying Kit
402 Whole Powered fixed wing flying kit
4021 Right aileron
4022 Left aileron
4023 Non-guided ammunition
4024 Elevator
4025 Rudder
4026 INS
4027 motor
4028 Propeller
403 Powered Multirotor Flying Kit
4031 motors
4032 INS
4033 Non-guided ammunition
4c Powered Flying Kit with cameras
404 Powered fixed wing flying kit with camera
4041 Right aileron
4042 Left aileron
4043 Non-guided ammunition
4044 Elevator
4045 Rudder
4046 INS
4047 Motor
4048 Propeller
4049 Camera
405 Powered Multirotor Flying Kit with camera
4051 Motors
4052 INS
4053 Non-guided ammunition
4054 Disposable camera
4055 Battery
501 fuselage
502 Left aileron
5021 servo to control left aileron
503 Right aileron
5031 servo to control right aileron
504 Elevator
5041 servo to control elevator
505 Rudder
5051 servo to control rudder
506 Ammunition mount
507 Non-guided ammunition
508 Battery
6a Fixed wing powered flying kit
601 The whole fixed wing powered flying kit
6011 fuselage
6012 left aileron
60121 servo to control left aileron
6013 right aileron
60131 servo to control right aileron
6014 elevator
6041 servo to control elevator
6015 rudder
60151 servo to control rudder
6016 ammunition mount
6017 Non-guided ammunition
6018 motor
6019 propeller
6020 INS
6021 battery
6022 communication cable
6b Multirotor powered flying kit
603 The whole multirotor powered flying kit
6031 motors
6032 INS
6033 Non-guided ammunition
6034 battery
6035 propeller guard
6036 propeller
6037 Communication cable
701 Communication cable reeler
702 reeler motor controlled by AI program
703 communication cable
704 cable tensioner and arranger
705 landing gears
706 landing gear rings

What is claimed is:

1. A system, comprising:
(a) a master flying object;
(b) at least one slave flying objects equipped with non-guided munitions;
(c) a smart cable system connects said master flying object and said at least one slave flying objects; and
(d) a target guidance module (TGM) connected to said master flying object, wherein said target guidance system (TGM) is operable to identify enemy targets, enemy coordinates, and controls said smart cable system to release said at least one slave flying objects to destroy said enemy targets.

2. The system of claim 1 wherein said master flying object is an unmanned aerial vehicle (UAV).

3. The system of claim 2 wherein said UAV is a multi-coper drone.

4. The system of claim 1 wherein said TGM further comprises a radar unit, a plurality of sensors, a laser ranging unit, a geolocation unit, and a plurality of cameras.

5. The system of claim 4 wherein said plurality of sensors further comprises a barometric sensor, a temperature sensor, a wind sensor, and an acoustic sensor.

6. The system of claim 5 wherein said geolocation unit further comprises a GPS unit, and a GNSS unit.

7. The system of claim 6 wherein said plurality of cameras further comprises RGB cameras and EO-IR cameras.

8. The system of claim 7 wherein said TGM further comprises an onboard computer operable to receive information from said radar unit, said plurality of sensors, said laser ranging unit, said geolocation unit, and said plurality of cameras to identify and locate coordinates of said enemy targets.

9. The system of claim 8 wherein said master flying object further comprises a self-flying module operable to autonomously fly said master flying object.

10. The system of claim 9 wherein said master flying object further comprises a wireless communication link unit for communicating with a base camp.

11. The system of claim 10 wherein said onboard computer further comprises a signal processing unit operable to select thermal signals, acoustic signals, or visible signals to communicate back to said base camp.

12. The system of claim 11 wherein said thermal signals are short wave infrared (SWIR) signals, said visible signals are generated by light emitting diodes (LEDs), and said acoustic signals are inaudible signals.

13. The system of claim 12 wherein said master flying object drone further comprising an inertia navigation system (INS), gyroscopes, accelerometers, and magnetic sensors.

14. The system of claim 13 wherein said camera system further comprises a gimbal equipped with a first camera and a second camera which operates independently with said first camera.

15. The system of claim 14 wherein said gimbal is an omni-sight gimbal operable like chameleon's eyes.

16. The system of claim 15 wherein said drone is capable of lifting more than 12 kg and having a reduction ratio of more than 95%.

17. The system of claim 1 wherein said at least one slave flying objects comprise an UAV.

18. The system of claim 17 wherein said UAV is a multicoper.

19. The system of claim 1 wherein said at least one slave flying object comprise a fixed wing aircraft.

20. The system of claim 1 wherein said at least one slave flying objects comprise non-guided munitions.
